(19) United States
(12) Patent Application Publication
(10) Pub. No.: US 2026/0257635 A1
(43) Pub. Date: Sep. 3, 2026

(54) VEHICLE DOOR ASSEMBLY POWER TRANSFER SYSTEM

(71) Applicant: Ford Global Technologies, LLC, Dearborn, MI (US)

(72) Inventors: Michael John Harmon, Northville, MI (US); Darren Luke, West Bloomfield, MI (US); Robert J. Gelardi, Plymouth, MI (US); Justin D. Sorum, Royal Oak, MI (US); Ricardo Haruo Sugimoto, Camaçari (BR); Abbas Ghamlouche, Dearborn, MI (US)

(21) Appl. No.: 19/066,609

(22) Filed: Feb. 28, 2025

(51) Int. Cl. B60R 16/027; B60R 16/03; E05D 3/02; H02J 50/10; H02J 50/80

(52) U.S. Cl. CPC B60R 16/027; B60R 16/03; E05D 3/02; H02J 50/10; H02J 50/80; E05Y 2400/65; E05Y 2900/531

(57) ABSTRACT

A vehicle assembly includes a door assembly having a door coil that is configured to interface with a vehicle coil to transfer power from a power supply on a vehicle to the door assembly. The door coil can interface with the vehicle coil to transmit data between the vehicle and the door assembly. The door assembly may be changeable back-and-forth between a first configuration and a second configuration. In the first configuration, the door assembly is provided by an inner module coupled to an outer module. In the second configuration, the door assembly is provided by the inner module without the outer module.

### TECHNICAL FIELD

This disclosure relates generally to power transfer between a body of a vehicle and doors of the vehicle.

### BACKGROUND

Some vehicles, particularly off-road vehicles, have removeable doors. In such vehicles, a user can remove at least a portion of an original door from a body of the vehicle. The user can then operate the vehicle. Removing at least a portion of the original door provides the user with a more open-air driving experience.

### SUMMARY

In some aspects, the techniques described herein relate to a vehicle assembly, including: a door assembly having a door coil that is configured to interface with a vehicle coil to transfer power from a power supply on a vehicle to the door assembly.

In some aspects, the techniques described herein relate to a vehicle assembly, wherein the door coil is configured to interface with the vehicle coil to transmit data between the vehicle and the door assembly.

In some aspects, the techniques described herein relate to a vehicle assembly, wherein the transfer is a wireless transfer.

In some aspects, the techniques described herein relate to a vehicle assembly, wherein the door assembly is a removable door assembly.

In some aspects, the techniques described herein relate to a vehicle assembly, wherein the door assembly is changeable back-and-forth between a first configuration and a second configuration, in the first configuration, the door assembly is provided by an inner module coupled to an outer module, in the second configuration, the door assembly is provided by the inner module without the outer module.

In some aspects, the techniques described herein relate to a vehicle assembly, wherein the door assembly in the first configuration is configured to cover more of a door opening than the door assembly in the second configuration.

In some aspects, the techniques described herein relate to a vehicle assembly, wherein the door coil and the vehicle coil are sandwiched between the inner module and a vehicle body of the vehicle when the inner module is in a closed position.

In some aspects, the techniques described herein relate to a vehicle assembly, wherein the door coil and the vehicle coil operatively interface with each other when the inner module is in a closed position.

In some aspects, the techniques described herein relate to a vehicle assembly, wherein the outer module is a door skin having a channel that receives the inner module when the door assembly is in the first configuration.

In some aspects, the techniques described herein relate to a vehicle assembly, further including at least one latch that couples the inner module to the outer module when the door assembly is in the first configuration.

In some aspects, the techniques described herein relate to a vehicle assembly, including: a door assembly; and at least one hinge assembly pivotably connecting the door assembly to a vehicle body, the at least one hinge assembly configured to transmit power from a power supply on a vehicle to the door assembly.

In some aspects, the techniques described herein relate to a vehicle assembly, wherein the at least one hinge assembly includes a hinge pin received within a hinge knuckle, the hinge pin having at least one pin contact that interfaces directly with at least one knuckle contact, wherein, within the at least one hinge assembly, power is transmitted between the at least one pin contact and the at least one knuckle contact.

In some aspects, the techniques described herein relate to a vehicle assembly, wherein the at least one pin contact includes at least one annular pin contact, and the at least one knuckle contact includes at least one annular knuckle contact.

In some aspects, the techniques described herein relate to a vehicle assembly, wherein the at least one annular knuckle contact is disposed circumferentially about the at least one pin contact.

In some aspects, the techniques described herein relate to a vehicle assembly, wherein the at least one hinge assembly is further configured to transmit data through the at least one hinge assembly.

In some aspects, the techniques described herein relate to a vehicle assembly, wherein the door assembly is changeable back-and-forth between a first configuration and a second configuration, in the first configuration, the door assembly is provided by an inner module coupled to an outer module, in the second configuration, the door assembly is provided by the inner module without the outer module.

In some aspects, the techniques described herein relate to a vehicle assembly, wherein the door assembly in the first configuration is configured to cover more of a door opening than the door assembly in the second configuration.

In some aspects, the techniques described herein relate to a vehicle assembly, wherein the outer module is a door skin having a channel that receives the inner module when the door assembly is in the first configuration.

In some aspects, the techniques described herein relate to a vehicle assembly, wherein the inner module is electrically coupled to the vehicle body when the inner module is in a closed position and when the inner module is in an open position.

In some aspects, the techniques described herein relate to a vehicle assembly, further including at least one latch that couples the inner module to the outer module when the door assembly is in the first configuration.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of a vehicle having a plurality of vehicle door assemblies each in a first configuration.

FIG. 2 illustrates the side view of the vehicle of FIG. 1 with the plurality of vehicle door assemblies each in a second configuration according to an exemplary aspect of the present disclosure.

FIG. 3 illustrates a perspective view of the vehicle of FIG. 2 with the vehicle door assemblies changed to the different, second configuration

FIG. 4 illustrates another perspective view of the vehicle of FIG. 3 showing a power transfer interface used in connection with one of the vehicle door assemblies.

FIG. 5 illustrates a perspective view of the power transfer interface of FIG. 4.

FIG. 6 illustrates a power transfer interface through a hinge that could be used in connection with the vehicle of FIGS. 1-5 according to another exemplary embodiment of the present disclosure.

FIG. 7 illustrates a section view through portions of the hinge of FIG. 6.

### DETAILED DESCRIPTION

This disclosure relates generally to transferring power, data, or both between a body of a vehicle and a door assembly of the vehicle without the use of conventional wired connectors, such as plug-in wire harnesses. In some examples, the vehicle door assemblies can include removable portions.

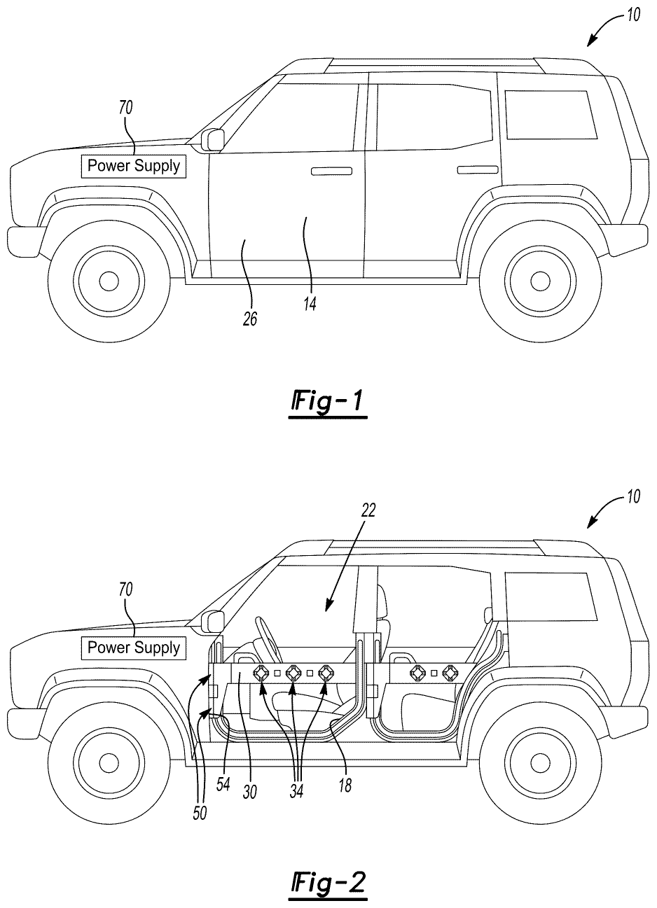

Referring to FIGS. 1 and 2, a vehicle 10 includes a door assembly 14 that is disposed within a door opening 18. The door assembly 14 is a driver side front door assembly. The exemplary vehicle 10 includes three additional vehicle door assemblies: a driver side rear door assembly, and front and rear door assemblies on a passenger side of the vehicle 10.

In FIG. 1, the door assembly 14 is in a first configuration and in a closed position. When in the first configuration and closed position, the door assembly 14 substantially covers the door opening 18 to help enclose a passenger compartment 22 of the vehicle 10.

In FIG. 2, the door assembly 14 is in a second configuration and in a closed position. When in the second configuration and closed position as shown, the door assembly 14 partially covers the door opening 18, which can provide a user within the passenger compartment 22 with a partial open-air experience. The door assembly 14 in the first configuration and the closed position covers more of the door opening 18 than the door assembly 14 in the second configuration. The door assembly 14 is changeable back-and-forth between the first configuration and the second configuration.

The door assembly 14 can be a removeable door assembly. The door assembly 14 includes, in the exemplary embodiment, an outer module 26 or door skin, and an inner module 30. When in the first configuration shown in FIG. 1, the outer module 26 and the inner module 30 are connected together. When in the second configuration of FIG. 2, the outer module 26 is disconnected from the inner module 30, and the door assembly 14 is provided by the inner module 30 without the outer module 26. In some examples, the inner module 30 could also be removed from the vehicle 10.

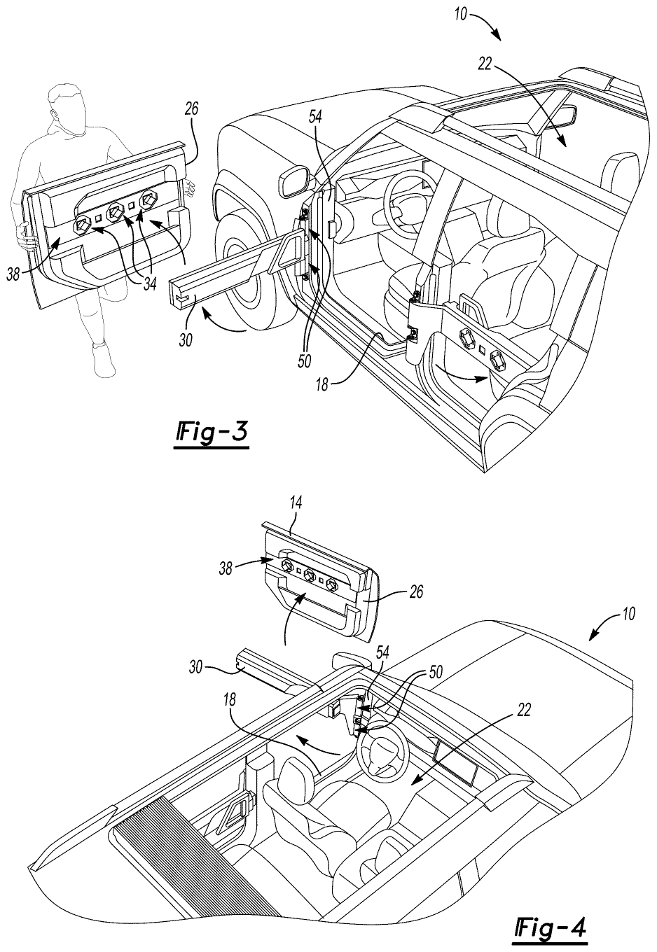

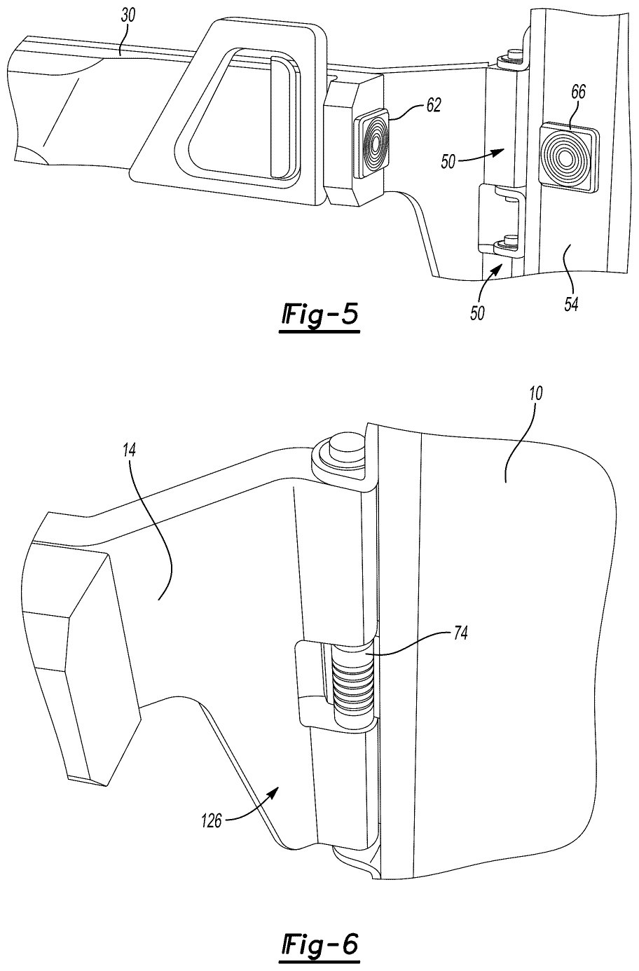

With reference now to FIGS. 3-5 and continuing reference to FIGS. 1-2, the outer module 26 can be latched to the inner module 30 via at least one latch assembly 34. In an example, the at least one latch assembly 34 can rely on feet that are received within apertures of a locking grid, such as the locking grid of the GRIDRACK™ system.

When in the first configuration, the inner module 30 is received within a channel 38 of the outer module 26. The at least one latch assembly 34 is disposed in areas where the inner module 30 interfaces with the walls of the channel 38.

In some examples, the latches that connect the outer module 26 to the inner module 30 can comprises e-latches that can be activated to unlock the outer module 26 from the inner module 30 only when the vehicle 10 is in a stationary position and in a parked gear. This can help to ensure that the outer module 26 only unlocks relative to the inner module 30 only when the vehicle 10 is locked in a stationary position.

To change the door assembly 14 from the first configuration to the second configuration, a user can unlatch the outer module 26 from the inner module 30 and then remove the outer module 26 from the inner module 30. The remaining doors of the vehicle 10 are configured similarly to the door assembly 14 and are able to be changed back-and-forth between the first configuration with an inner module coupled to an outer module, and a second configuration that only uses the inner module to provide a door assembly.

In this example, the outer module 26 includes a window of the door assembly 14. The majority of the mechanisms and electronics associated with the door assembly 14 reside within the inner module 30. This can reduce weight and complexity of the outer module 26, which can facilitate separating the outer module 26 from the inner module 42. The user is not required to lift the mechanism and electronics within the inner module 30 when changing the door assembly 14 from the first configuration to the second configuration.

Hinges 50 connect the door assembly 14 in the first configuration to a vehicle body 54 of the vehicle 10. The same hinges 50 connect the door assembly 14 in the second configuration to the vehicle body 54. The door assembly 14 can pivot about the hinges 50 back-and-forth between the closed position and an open position when the door assembly 14 is in the first configuration and when the door assembly 14 is in the second configuration.

In this example, power is transferred to the door assembly 14 through a wireless interface, which includes a door coil 62 on the inner module 30 and a corresponding vehicle coil 66 mounted on a vehicle body 54 of the vehicle 10. The door coil 62 can be considered a receiver coil, and the vehicle coil 66 can be considered a transmitter coil. Power can be transferred to the vehicle coil 66 from a power supply 70 on the vehicle 10, such as an accessory battery.

When the inner module 42 is in the closed position, the door coil 62 interfaces directly with the vehicle coil 66. When the inner module 42 is in the closed position, the door coil 62 and the vehicle coil 66 are sandwiched between the inner module 42 and vehicle body 54.

The door coil 62 and the vehicle coil 66 are configured, in this example, to transmit both power and data wirelessly between the vehicle 10 and the door assembly 14 when the door assembly 14 is in the closed position. The transmission can be an indictive transmission between the door coil 62 and the vehicle coil 66. The utilization of the indictive transfer of data and power between the vehicle 10 and the inner module 42 means that wired connectors extending from the inner module 42 to connect the door assembly 14 to other portions of the vehicle 10 can be omitted.

Moving the inner module 42 to the open position causes the door coil 62 and the vehicle coil 66 to separate. Thus, data and power transmission through the door coil 62 and the vehicle coil 66 can, in this example, occur only when the inner module 42 of the door assembly 14 is in the closed position.

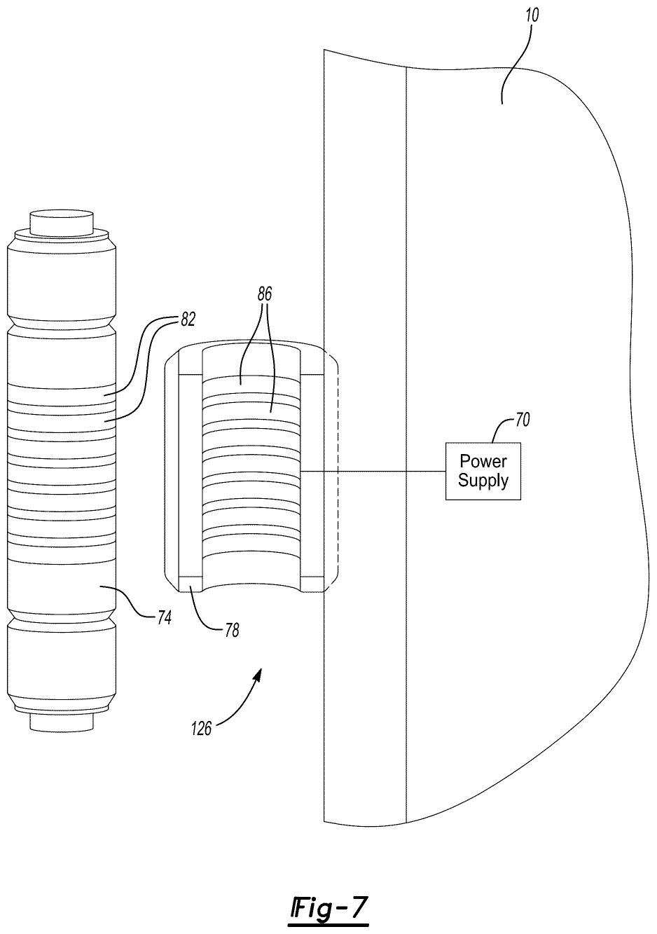

With reference now to FIGS. 6 and 7, another method of transferring power and, optionally, data from the vehicle 10 to a door assembly 14 utilizes at least one hinge assembly 126, which can include a hinge pin 74 received within at least one hinge knuckle 78, which, in this example, is electrically coupled to the power supply 70 on the vehicle 10. The at least one hinge knuckle 78 is electrically coupled to the door assembly 14.

The hinge pin 74 incorporates a plurality of annular pin contacts 82. The hinge knuckle 78 is lined with annular knuckle contacts 86. This example includes seven pin contacts 82 and seven knuckle contacts 86. Other examples could include more than seven or fewer than seven pin contacts 82 and knuckle contacts 86.

When the door assembly 14 is installed, the hinge pin 74 is received within the at least one hinge knuckle 78, and the pin contacts 82 interface directly with the knuckle contacts 86. The knuckle contacts 86 are disposed circumferentially about the pin contacts 82. Data and power can be passed between the pin contacts 82 and the knuckle contacts 86 to transfer power and data between the door assembly 14 and the vehicle 10.

The interfacing relationship between the pin contacts 82 and the knuckle contacts 86 is maintained as the door assembly 14 is pivoted back-and-forth between the closed position and an open position. Unlike the interface described in connection with the embodiment of FIGS. 1-5, power and data can continue to be transferred to and from the door assembly 14 through the hinge assembly 126 when the door assembly 14 is in the open position. The window of the door assembly 14 can thus be raised and lowered with the door assembly 14 in an open position.

Features of the disclosed examples include transferring power and, optionally, data to a door assembly, which can be a modular door assembly. The power and data transfer can avoid the need for plug-in wire bundles and connectors between the door assembly and the remaining portions of the vehicle.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

1. A vehicle assembly, comprising:
a door assembly having a door coil that is configured to interface with a vehicle coil to transfer power from a power supply on a vehicle to the door assembly, the door assembly being pivotably connected to a body of the vehicle by a hinge, and the door coil and the vehicle coil being spaced from the hinge and configured to interface with each other to transfer the power to the door assembly only when the door assembly is in a closed position, and to separate from each other when the door assembly is in an open position.

2. The vehicle assembly of claim 1, wherein the door coil is configured to interface with the vehicle coil to transmit data between the vehicle and the door assembly.

3. The vehicle assembly of claim 1, wherein the transfer is a wireless transfer.

4. The vehicle assembly of claim 1, wherein the door assembly is a removable door assembly.

5. The vehicle assembly of claim 1, wherein the door assembly is changeable back-and-forth between a first configuration and a second configuration,
in the first configuration, the door assembly is provided by an inner module coupled to an outer module,
in the second configuration, the door assembly is provided by the inner module without the outer module.

6. The vehicle assembly of claim 5, wherein the door assembly in the first configuration is configured to cover more of a door opening than the door assembly in the second configuration.

7. The vehicle assembly of claim 5, wherein the door coil and the vehicle coil are sandwiched between the inner module and a vehicle body of the vehicle when the inner module is in a closed position.

8. The vehicle assembly of claim 5, wherein the door coil and the vehicle coil operatively interface with each other when the inner module is in a closed position.

9. The vehicle assembly of claim 5, wherein the outer module is a door skin having a channel that receives the inner module when the door assembly is in the first configuration.

10. The vehicle assembly of claim 5, further comprising at least one latch that couples the inner module to the outer module when the door assembly is in the first configuration.

11-20. (canceled)

21. The vehicle assembly of claim 1, wherein the door coil is a receiver coil and the vehicle coil is a transmitter coil, and the power is transferred from the vehicle coil to the door coil by inductive coupling.

22. The vehicle assembly of claim 1, wherein the power supply is an accessory battery of the vehicle.

23. The vehicle assembly of claim 5, wherein the door coil is carried by the inner module such that the power is transferred to the inner module both in the first configuration and in the second configuration.

24. The vehicle assembly of claim 5, wherein a majority of electronics of the door assembly are housed within the inner module.

25. The vehicle assembly of claim 5, wherein the outer module includes a window of the door assembly.

26. The vehicle assembly of claim 10, wherein the at least one latch comprises an e-latch configured to unlock the outer module from the inner module only when the vehicle is in a stationary position and in a parked gear.

27. The vehicle assembly of claim 10, wherein the at least one latch comprises a foot received within an aperture of a locking grid.

28. A vehicle assembly, comprising:
a body of a vehicle carrying a vehicle coil coupled to a power supply; and a door assembly pivotably connected to the body by a hinge for movement between a closed position and an open position, the door assembly carrying a door coil at a location spaced from the hinge, wherein the door coil and the vehicle coil interface with each other to transfer power from the power supply to the door assembly only when the door assembly is in the closed position and separate from each other when the door assembly is in the open position.

29. The vehicle assembly of claim 21, wherein the door coil and the vehicle coil are sandwiched between the door assembly and the body of the vehicle when the door assembly is in the closed position.

30. The vehicle assembly of claim 21, wherein the door coil and the vehicle coil are further configured to interface to transmit data between the body of the vehicle and the door assembly.
